(19) United States
(12) Patent Application Publication
(10) Pub. No.: US 2008/0037275 A1
(43) Pub. Date: Feb. 14, 2008

(54) Laundry Treatment Machine Comprising an Illumination Device

(75) Inventors: Alfons Eblenkamp, Rietberg (DE); Markus Hain, Guetersloh (DE)

Correspondence Address: DARBY & DARBY P.C., P.O. BOX 770, Church Street Station, New York, NY, 10008-0770, US

(73) Assignee: MIELE & CIE. KG, Guetersloh (DE)

(21) Appl. No.: 10/599,315

(22) PCT Filed: Mar. 24, 2005
(86) PCT No.: PCT/EP05/03142

§ 371 Date: Sep. 25, 2006

(30) Foreign Application Priority Data
Mar. 25, 2004 (DE) 10 2004 015 078.8

(51) Int. Cl. F21V 33/00; F21V 8/00

(52) U.S. Cl. 362/610; 362/615

(57) ABSTRACT

A laundry appliance includes a housing having a stamped section recessed relative to a front of the housing and circumferentially surrounding a loading opening to a rotatably mounted drum of the appliance. A door is disposed on the front of the housing for closing the loading opening. An edge of the door and a surrounding edge of the stamped section form a gap area between them when the door is in a closed position. An illumination device is disposed in the stamped section so as to be concealed behind the door when the door is in the closed position. Light of the illumination device is reflected at an edge surface of the stamped section and a surface of the door edge so as to provide an illuminating ring visible at the front of the housing in the gap area.

### CROSS REFERENCE TO PRIOR APPLICATION

This is a U.S. national phase application under 35 U.S.C. §371 of International Patent Application No. PCT/EP2005/003142, filed Mar. 24, 2005, and claims benefit of German Patent Application No. 10 2004 015 78.8, filed Mar. 25, 2004, which is incorporated by reference herein. The International Application was published in German on Oct. 6, 2005 as WO 2005/093149 A1 under PCT Article 21(2).

The present invention relates to a laundry appliance having an illumination device in the area of the door, the door being disposed in the appliance housing on the front and closing the loading opening to the rotatably mounted drum, an illuminating ring circumferentially surrounding the edge of the door.

### BACKGROUND

A laundry appliance having an illumination device in the area of the door is known from DE 101 44 668 A1. The illumination device described therein has an illuminating ring which surrounds the porthole or the circumferential edge of the porthole. The illuminating ring includes individual light-emitting diodes which map the speed of rotation of the drum by lighting up consecutively in the circumferential direction. This gives the observer the impression of a point of light that moves along the illuminating ring and whose direction of rotation is that same as that of the drum. This system does not allow for uniform, glare-free illumination in the edge area of the door.

Document WO 02/14593 A2 describes a laundry appliance in which the door to the loading opening of the drum is provided with an illumination device which indicates program stages.

Document DE 41 00 767 A1 discloses an annular illumination device for a household appliance, said annular illumination device being designed as an optical waveguide and used, for example, as a visual edge boundary for cooktops or rotary selector switches.

In Document DE 196 49 039 C1 describes a drum-type washing machine having an illumination device whose light source is located in the area of the door hinge, and in which the light input and light output surfaces of an optical waveguide are arranged in a manner allowing the interior of the laundry drum and the area in front of the loading opening to be illuminated when the door is closed and when it is open.

The light source of that illumination device is mounted in the area of the door hinge and connected to the light-emitting means via a light-conductive connection. The door glass of the door is used as the light-emitting means, said door glass being in light-conductive connection with the light source via optical waveguides. This arrangement illuminates the interior of the drum. The loading opening and the space in front of the loading opening are illuminated when the door is in the open position.

Document DE 42 20 018 A1 discloses an illumination device for a laundry appliance, where the light source is disposed in the filling ring outside the sealing area of the suds container, and in such a manner that it is accessible from outside the appliance when the door is open. In this design, the edge of the drum acts as a reflector and the door glass provides assistance as an optical waveguide. When the door is open, the area in front of the appliance is also illuminated.

In order to illuminate the area in front of the appliance, it is known from U.S. Pat. No. 3,220,229 to mount an illumination device above the loading opening of the drum, said illumination device illuminating the area in front of the appliance when the door is closed. The lamp is disposed behind a hinged service cover for the condensation device, said service cover having a glass panel to illuminate the area in front of the appliance.

### SUMMARY

An object of the present invention is to provide a laundry appliance having an illumination device in a manner that allows for glare-free illumination of the edge area of the door both in appliances with a door glass and in appliances that do not have a door glass.

The present invention provides a laundry appliance. The laundry appliance includes a housing including a stamped section recessed relative to a front of the housing and circumferentially surrounding a loading opening to a rotatably mounted drum of the appliance. A door is disposed on the front of the housing for closing the loading opening, an edge of the door and a surrounding edge of the stamped section forming a gap area therebetween when the door is in a closed position. An illumination device is disposed in the stamped section so as to be conceled behind the door when the door is in the closed position, light of the illumination device being reflected at an edge surface of the stamped section and a surface of the door edge so as to provide an illuminating ring visible at the front of the housing in the gap area.

### BRIEF DESCRIPTION OF THE DRAWINGS

Exemplary embodiments of the present invention are shown in the drawings in a schematic way and will be described in more detail below. In the drawings,

FIG. 1 is a view showing illumination device (7) of the laundry appliance along with an optical waveguide (9);

FIG. 2 is a cross-sectional side view taken along line A-A, showing the area of loading opening (2) and including a schematic representation of illumination device (7) with door (3) in the closed position; and

FIG. 3 is a cross-sectional side view showing three variants 3a, 3b and 3c of arranging illumination device (7) in stamped section (10, 11).

### DETAILED DESCRIPTION

One particular advantage that can be achieved with the present invention is provided by the illumination device which is arranged such that it is concealed behind the edge of the door and produces an illuminating ring in the gap area between the door and the housing by light reflection at the edge surfaces of the stamped section in the housing front and at the door edge. Due to the concealed arrangement of the illumination device, the illuminating ring becomes visible at the front of the housing without producing glare. The illumination device can be similarly arranged in laundry machines having a door of closed design which does not have a door glass.

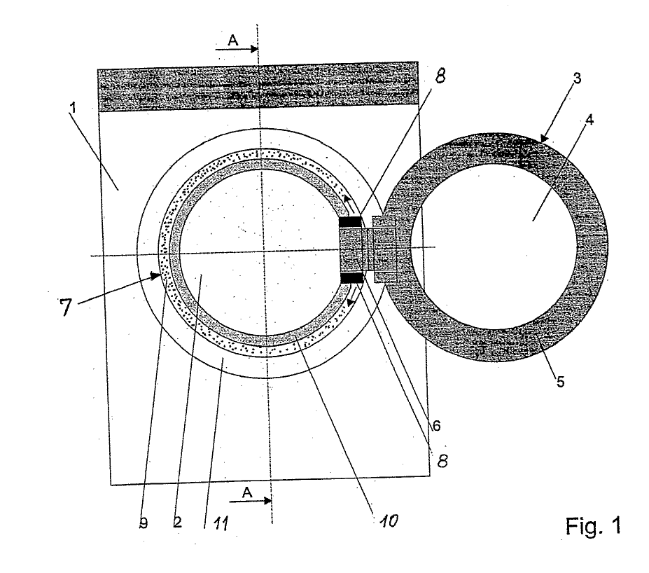

FIG. 1 shows the housing front (1) of a laundry appliance, including a door (3) closing the loading opening (2) to the drum. Door (3) is provided with a door glass (4) whose edge is surrounded by a retaining ring (5). Retaining ring (5) is used for the attachment of door hinge (6) and the locking mechanism parts on the side of the door, which are not shown here. Illumination device (7) is disposed in the area of loading opening (2) and includes at least one light source (8). Light source (8) is disposed at door hinge (6) and is in light-conductive connection with optical waveguide (9) of illumination device (7). Optical waveguide (9) of illumination device (7) circumferentially surrounds front loading opening (2). In the area of door hinge (6), optical waveguide (9) has one or more light input surfaces and is in light-conductive connection with light source (8) at door hinge (6). Optical waveguide (9) is provided with light output surfaces in the circumferential direction, which is represented in the drawing by the dots distributed over the periphery.

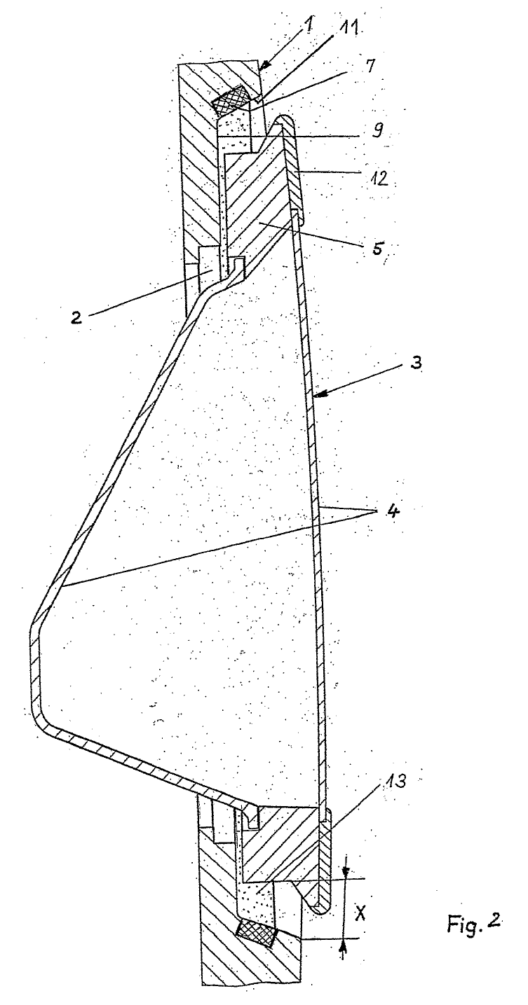

FIG. 2 is a side view showing the area of loading opening (2) and illumination device (7) with door (3) in the closed position. Loading opening (2) is located in a stamped section (10, 11) which is set back from housing front (1) of the appliance and provides a stop surface (10, shown shaded in FIG. 1) for door (3).

Edge surface (11), which surrounds stop surface (10) of the stamped section, is shaped as a truncated cone. In the closed position, door (3) is received in the stamped section in housing front (1) approximately flush therewith. Retaining ring (5) for door glass (4) is provided on the front with an annular cover (12) which, when door (3) is closed, partially covers the annular gap (13) that exists between retaining ring (5) and edge surface (11) surrounding circular stop surface (10) and which has the dimension X (gap area).

The light of concealed illumination device (7) is reflected at edge surfaces (11) of the stamped section and at stop surface (10). Thus, annular gap (13) is uniformly illuminated, so that an illuminating ring becomes visible toward housing front (1).

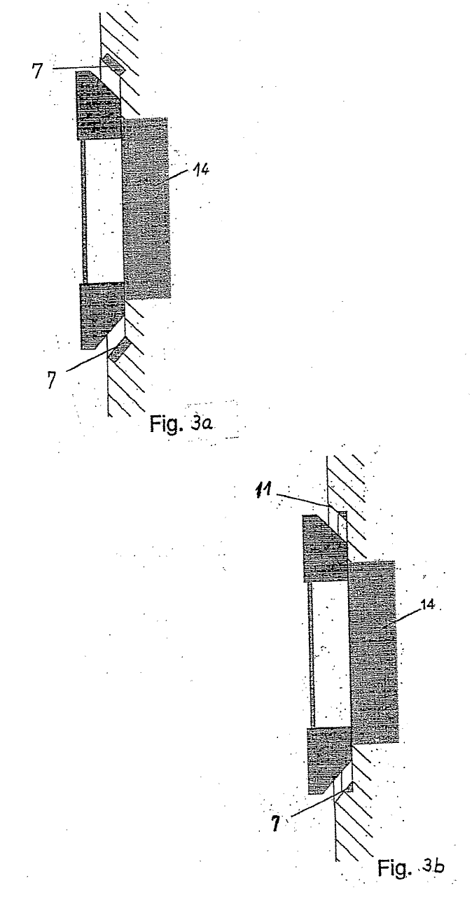

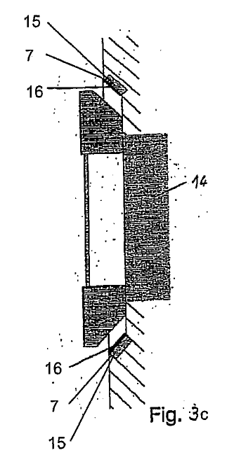

FIGS. 3a and 3b are schematic cross-sectional side views of a stamped section (10, 11) having a truncated-cone-shaped edge surface (11), in which is received an integrated illumination device (7) including optical waveguide (9). Shaded area (14) is intended to symbolize the adjacent drum of the laundry appliance.

FIG. 3c is a schematic cross-sectional side view of a stamped section (10, 11) having a truncated-cone-shaped edge surface (11), in which is received another embodiment of integrated illumination device (7). In this embodiment, the illumination device (7) is in the form of LEDs (15) which are arranged circumferentially around the loading opening in stamped section (10, 11) and backlight a diffuser or a diffusing screen (16).

The above-described variants of the illumination devices make it possible to indicate different operating states of the appliance. The light sources can, for example, be driven such that, for example, blinking white light symbolizes the program start. Moreover, it is possible to additionally provide colored light sources which can be used to indicate malfunctions (red light) or the end of the program (green light), when driven accordingly. The illumination device can be similarly arranged in laundry machines having a door of closed design which does not have a door glass.

The present invention is not limited to the exemplary embodiments described herein; reference should be had to the appended claims.

1-4. (canceled)

5. A laundry appliance comprising:
a housing including a stamped section recessed relative to a front of the housing and circumferentially surrounding a loading opening to a rotatably mounted drum of the appliance;
a door disposed on the front of the housing for closing the loading opening, an edge of the door and a surrounding edge of the stamped section forming a gap area therebetween when the door is in a closed position; and
an illumination device disposed in the stamped section so as to be concealed behind the door when the door is in the closed position, light of the illumination device being reflected at an edge surface of the stamped section and a surface of the door edge so as to provide an illuminating ring visible at the front of the housing in the gap area.

6. The laundry appliance as recited in claim 5 wherein the illumination device includes:
a light source disposed in an area of a hinge of the door; and
an optical waveguide having a light output surface at a periphery thereof.

7. The laundry appliance as recited in claim 6 wherein the optical waveguide includes a light input surface configured to provide a light-conductive connection with the light source in the area of the hinge of the door.

8. The laundry appliance as recited in claim 5 wherein the illumination device includes a diffuser and a plurality of LEDs configured to back-light the diffuser, the LEDs being circumferentially spaced at an edge area of the front loading opening.
